(19) United States
(12) Patent Application Publication
(10) Pub. No.: US 2008/0159558 A1
(43) Pub. Date: Jul. 3, 2008

(54) INTERNAL MICROPHONE ARRAY OR MICROPHONE MODULE NOT AFFECTING APPEARANCE OF ELECTRONIC DEVICE

(75) Inventors: Yu-Hsi Lan, Hsinchu County (TW); Shien-Neng Lai, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 11/751,140

(22) Filed: May 21, 2007

Related U.S. Application Data
(60) Provisional application No. 60/882,239, filed on Dec. 28, 2006.

(51) Int. Cl. H04R 1/02

(52) U.S. Cl. 381/91

(57) ABSTRACT

A microphone module includes a microphone and a boot. The microphone has a front surface and a rear surface. The boot includes an internal storage space with the microphone disposed therein, an acoustic passage connected to the internal storage space, and an opening also connected to the internal storage space. The acoustic passage runs substantially parallel to the front surface of the microphone, and the opening exposes the rear surface of the microphone.

### CROSS REFERENCE TO RELATED APPLICATIONS

This application claims the benefit of U.S. Provisional Application No. 60/882,239, filed on Dec. 28, 2006.

### BACKGROUND OF THE INVENTION

1. Field of the Invention

The invention relates to an internal microphone array or microphone module capable of adequate performance without affecting the appearance of electronic devices.

2. Description of the Related Art

A microphone array is capable of clearly receiving sound from a particular direction and avoiding environmental noise, and thus is often applied in high-quality audio recorders or communications devices.

Most electronic devices (cellular phones, personal digital assistants, etc.) have plastic or metal housings which act as acoustic isolators. Acoustic isolators block sound waves, increasing the difficulty of microphone placement. Specifically, microphone array performance, acceptable in open space, deteriorates when disposed in a housing of an electronic device, because reception of external sound is hindered by the housing. It is therefore commonly understood that a microphone array is often externally connected to an electronic device to achieve adequate quality.

### BRIEF SUMMARY OF THE INVENTION

The invention provides an electronic device comprising an internal microphone array capable of adequate performance.

In an exemplary embodiment of the invention, the microphone module includes a microphone and a boot. The microphone has a front surface and a rear surface. The boot includes an internal storage space with the microphone disposed therein, an acoustic passage connected to the internal storage space, and an opening also connected to the internal storage space. The acoustic passage runs substantially parallel to the front surface of the microphone, and the opening exposes the rear surface of the microphone.

The boot may be substantially cylindrical.

The boot may be substantially rectangular.

The boot may comprise rubber.

The microphone may be a unidirectional microphone.

The microphone may be an omnidirectional microphone.

In another exemplary embodiment of the invention, the electronic device includes a chamber and a microphone module disposed in the chamber. The chamber has a first hole at an edge of the electronic device. The microphone module includes a microphone and a boot. The microphone has a front surface and a rear surface. The boot includes an internal storage space with the microphone disposed therein, an acoustic passage connected to the internal storage space, and an opening also connected to the internal storage space. The acoustic passage runs substantially parallel to the front surface of the microphone, from the first hole to the internal storage space. The opening exposes the rear surface of the microphone.

The electronic device may further comprise a permeable cover covering the first hole.

The electronic device may further comprise a perforated cover covering the first hole.

The chamber may further have a second hole at a rear of the electronic device, allowing external sound to arrive at the rear surface of the microphone through the opening of the boot.

The electronic device may further comprise a permeable cover covering the second hole.

The electronic device may further comprise a perforated cover covering the second hole.

An empty space may be provided in the chamber adjacent to the rear surface of the microphone.

The electronic device may further comprise another microphone module also disposed in the chamber, wherein the microphone modules are placed side-by-side.

The electronic device may further comprise another microphone module also disposed in the chamber, wherein the microphone modules are placed back-to-back.

The electronic device may further comprise another microphone module also disposed in the chamber, wherein the microphone modules are placed face-to-face.

The electronic device may further comprise another microphone module also disposed in the chamber, wherein the microphone modules are placed face-to-back.

The microphone module of the invention presents many benefits. For example, the directivity of the microphone array is effectively maintained even when the microphone array is disposed in a thick electronic device. The housing of the electronic device is provided with a minimum number of holes for the microphone array to receive external sound, thus without affecting the appearance of the electronic device. The rubber boot and the microphone constitute a module, facilitating assembly of the electronic device.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of a unidirectional microphone;

FIG. 2 depicts a microphone module in accordance with an embodiment of the invention;

FIG. 3A is a left side view showing the rubber boot of the microphone module of FIG. 2;

FIG. 3B depicts a modified rubber boot of the microphone module of FIG. 3A;

FIG. 4 depicts the microphone module of FIG. 2 disposed in a chamber of a thin electronic device;

FIG. 5 depicts the microphone module of FIG. 2 disposed in a chamber of a thick electronic device;

FIG. 6 is a sectional view of an electronic device in accordance with an embodiment of the invention, observed from the top thereof;

FIG. 7 depicts the electronic device of FIG. 6, with a hole thereof covered with a permeable cover;

FIG. 8 depicts the electronic device of FIG. 6, with a hole thereof covered with a perforated cover;

FIG. 9 depicts a unidirectional microphone and an omnidirectional microphone placed back-to-back;

FIG. 10 depicts a unidirectional microphone and an omnidirectional microphone placed face-to-face in accordance with an embodiment of the invention;

FIG. 11 depicts a unidirectional microphone and an omnidirectional microphone placed face-to-back in accordance with another embodiment of the invention;

FIG. 12A is a perspective diagram of a thin electronic device provided with a microphone array of the invention;

FIG. 12B is a perspective diagram of the thin electronic device of FIG. 12A, observed from another direction;

FIG. 13 is a perspective diagram of a thick electronic device provided with a microphone array of the invention; and

FIG. 14 is a perspective diagram of another thick electronic device provided with a microphone array of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

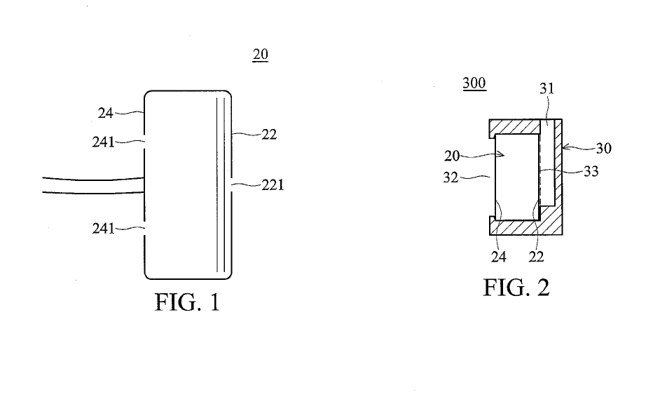

FIG. 1 shows a unidirectional microphone more sensitive to sound from a particular direction (typically the front side). The unidirectional microphone 20 receives sound waves via a sound port 221 on its front surface 22 and two sound ports 241 on its rear surface 24. The sound waves received via the sound ports 241 are cancelled by the sound waves received via the sound port 221, thereby creating low sensitivity for the rear side.

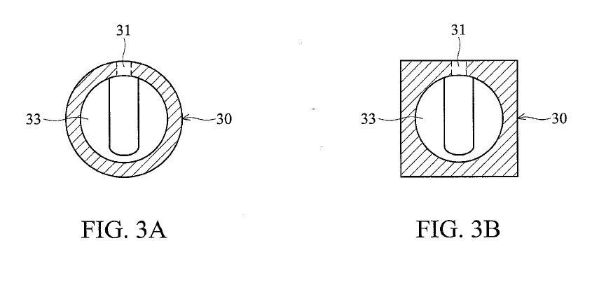

FIG. 2 depicts a microphone module 300 which includes a rubber boot 30 and a unidirectional microphone 20 disposed in the rubber boot 30. The rubber boot 30 may be substantially cylindrical as shown in FIG. 3A, rectangular as shown in FIG. 3B, or in other shapes. The rubber boot 30 has an internal storage space 33 receiving the unidirectional microphone 20, an acoustic passage 31 connected to the internal storage space 33 for introducing external sound to the front surface 22 of the unidirectional microphone 20, and an opening 32 also connected to the internal storage space 33 allowing external sound to reach the rear surface 24 of the unidirectional microphone 20. Note that the opening 32 exposes the rear surface 24 of the unidirectional microphone 20. In this embodiment, the acoustic passage 31 runs substantially parallel to the front surface 22 of the unidirectional microphone 20. That is, the sound port 221 of the front surface 22 of the unidirectional microphone 20 is directed away from the acoustic passage 31 at about 90°, which is advantageous to the performance of the unidirectional microphone 20.

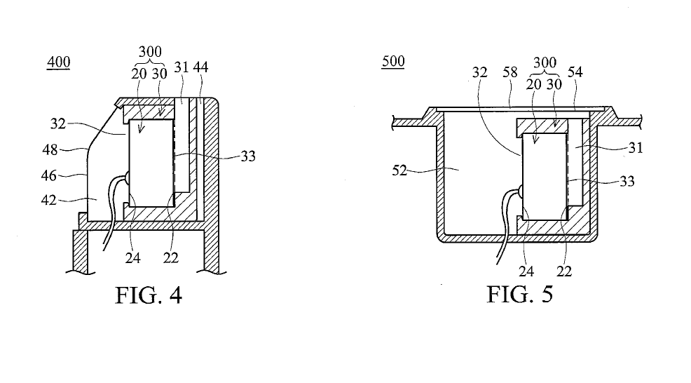

FIG. 4 depicts the microphone module 300 disposed in a chamber 42 of an electronic device 400, wherein the electronic device 400 is “thin”. The rubber boot 30 protects the internal unidirectional microphone 20 from vibration. The chamber 42 has a first hole 44 at the top of the electronic device 400 and a second hole 46 at the rear of the electronic device 400. The acoustic passage 31 of the rubber boot 30 runs from the first hole 44 to the internal storage space 33. A permeable cover or a perforated cover (e.g. grill, mesh, etc.) 48 is provided to cover the second hole 46 for preventing entry of dust. In operation, the unidirectional microphone 20 receives external sound via the first hole 44 and second hole 46 of the chamber 42, wherein the first hole 44 allows the external sound to arrive at the front surface 22 of the unidirectional microphone 20, and the second hole 46 allows the external sound to arrive at the rear surface 24 of the unidirectional microphone 20. In the chamber 42, an empty space is provided adjacent to the rear surface 24 of the unidirectional microphone 20, which is advantageous to the performance of the unidirectional microphone 20.

FIG. 5 depicts the microphone module 300 disposed in a chamber 52 of an electronic device 500, wherein the electronic device 500 is “thick”. The rubber boot 30 protects the internal unidirectional microphone 20 from vibration. The chamber 52 has a hole 54 at the top of the electronic device 500. The acoustic passage 31 of the rubber boot 30 runs from the hole 54 to the internal storage space 33. A permeable cover or a perforated cover (e.g. grill, mesh, etc.) 58 is provided to cover the hole 54 for preventing entry of dust. In operation, the unidirectional microphone 20 receives external sound via the hole 54 of the chamber 52, wherein the external sound travels in two paths:

The external sound propagates through the permeable cover (or perforated cover) 58, enters into the acoustic passage 31, and arrives at the front surface 22 of the unidirectional microphone 20.

Alternatively, the external sound propagates through the permeable cover (or perforated cover) 58 and the opening 32 of the rubber boot 30, and then arrives at the rear surface 24 of the unidirectional microphone 20.

Similarly, in the chamber 52, an empty space is provided adjacent to the rear surface 24 of the unidirectional microphone 20.

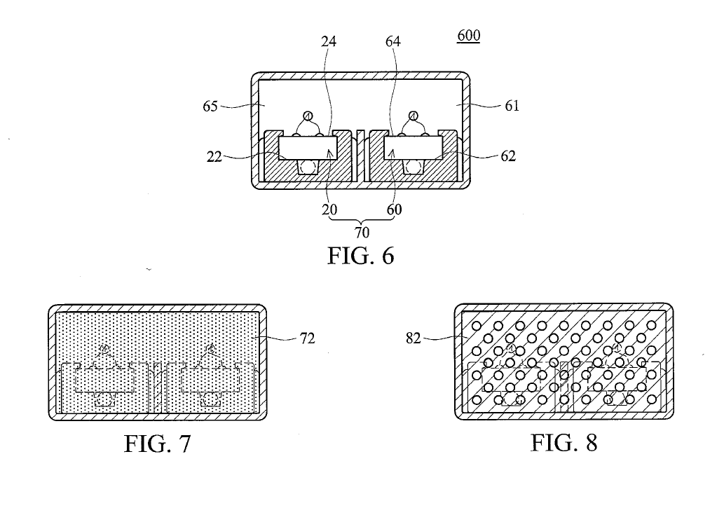

FIG. 6 is a sectional view of an electronic device 600, observed from the top thereof. A unidirectional microphone 20 and an omnidirectional microphone 60 are placed side-by-side in a chamber 61 of the electronic device 600. Thus, the front surface 22 of the unidirectional microphone 20 and the front surface 62 of the omnidirectional microphone 60 face the same direction (a first direction), and the rear surface 24 of the unidirectional microphone 20 and the rear surface 64 of the omnidirectional microphone 60 face another direction which opposes the first direction.

The unidirectional microphone 20 and the omnidirectional microphone 60 constitute a microphone array 70. The chamber 61 has a hole 65 at the top of the electronic device 600 for the microphone array 70 to receive external sound. The hole 65 can be covered with a permeable cover (e.g. dust proof fabric) 72 as shown in FIG. 7, or a perforated cover 82 as shown in FIG. 8. Note that this embodiment is applicable to both “thick” and “thin” electronic devices.

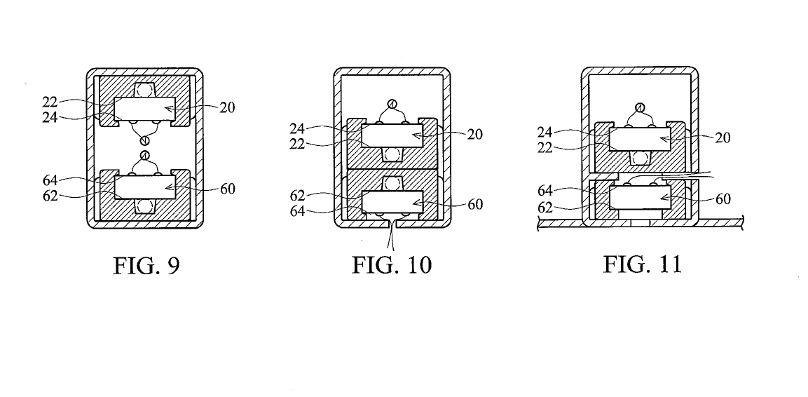

It is understood that the unidirectional microphone 20 and the omnidirectional microphone 60 can be arranged in various ways. As shown in FIG. 9, for example, the unidirectional microphone 20 and the omnidirectional microphone 60 are placed back-to-back, wherein the rear surface 24 of the unidirectional microphone 20 faces the rear surface 64 of the omnidirectional microphone 60. In FIG. 10, for another example, the unidirectional microphone 20 and the omnidirectional microphone 60 are placed face-to-face, wherein the front surface 22 of the unidirectional microphone 20 faces the front surface 62 of the omnidirectional microphone 60. In FIG. 11, for another example, the unidirectional microphone 20 and the omnidirectional microphone 60 are placed face-to-back, wherein the front surface 22 of the unidirectional microphone 20 faces the rear surface 64 of the omnidirectional microphone 60.

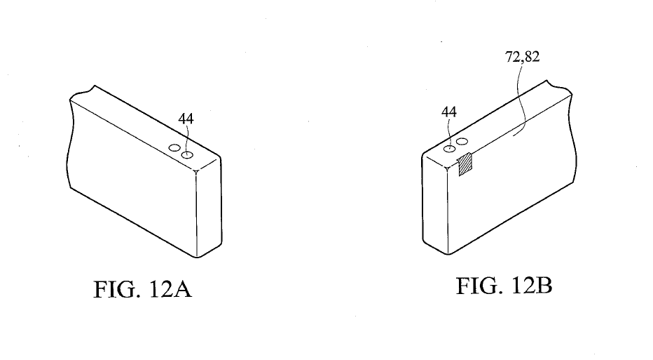

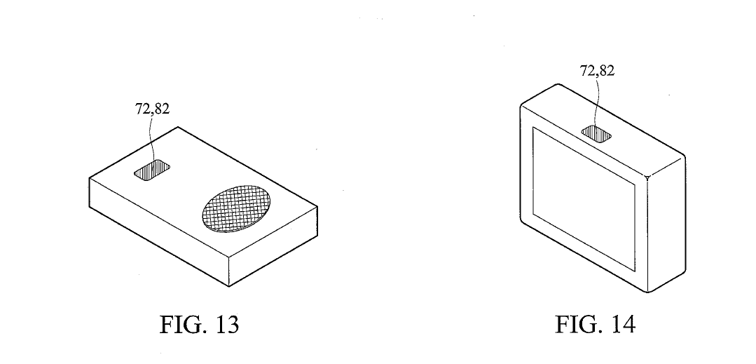

As described, the microphone modules of the invention are applicable to thick and/or thin electronic devices. FIGS. 12A and 12B depict a thin electronic device, wherein the top of the electronic device is not wide enough to provide a large hole. Therefore, the first hole 44 which is small is provided at the top of the electronic device, and the second hole 46 which is larger than the first hole 44 and covered with a permeable cover 72 or a perforated cover 82, is provided at the rear of the electronic device. FIG. 13 and FIG. 14 respectively depict two different thick electronic devices, wherein the top of each electronic device is wide enough to provide a large hole thereon.

The microphone module of the invention presents many benefits. For example, the directivity of the microphone array is effectively maintained even when the microphone array is disposed in a thick electronic device. The housing of the electronic device is provided with a minimum number of holes for the microphone array to receive external sound, thus without affecting the appearance of the electronic device. The rubber boot and the microphone constitute a module, facilitating assembly of the electronic device.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A microphone module, comprising:
a microphone having a front surface and a rear surface; and
a boot comprising an internal storage space with the microphone disposed therein, an acoustic passage connected to the internal storage space, and an opening also connected to the internal storage space, wherein the acoustic passage runs substantially parallel to the front surface of the microphone, and the opening exposes the rear surface of the microphone.

2. The microphone module as claimed in claim 1, wherein the boot is substantially cylindrical.

3. The microphone module as claimed in claim 1, wherein the boot is substantially rectangular.

4. The microphone module as claimed in claim 1, wherein the boot comprises rubber.

5. The microphone module as claimed in claim 1, wherein the microphone is a unidirectional microphone.

6. The microphone module as claimed in claim 1, wherein the microphone is an omnidirectional microphone.

7. An electronic device, comprising:
a chamber having a first hole at an edge of the electronic device; and
the microphone module of claim 1, disposed in the chamber, wherein the acoustic passage runs from the first hole to the internal storage space.

8. The electronic device as claimed in claim 7, further comprising a permeable cover covering the first hole.

9. The electronic device as claimed in claim 7, further comprising a perforated cover covering the first hole.

10. The electronic device as claimed in claim 7, wherein the chamber further has a second hole at a rear of the electronic device, allowing external sound to arrive at the rear surface of the microphone through the opening of the boot.

11. The electronic device as claimed in claim 10, further comprising a permeable cover covering the second hole.

12. The electronic device as claimed in claim 10, further comprising a perforated cover covering the second hole.

13. The electronic device as claimed in claim 7, wherein an empty space is provided in the chamber adjacent to the rear surface of the microphone.

14. The electronic device as claimed in claim 7, further comprising another microphone module also disposed in the chamber, wherein the microphone modules are placed side-by-side.

15. The electronic device as claimed in claim 7, further comprising another microphone module also disposed in the chamber, wherein the microphone modules are placed back-to-back.

16. The electronic device as claimed in claim 7, further comprising another microphone module also disposed in the chamber, wherein the microphone modules are placed face-to-face.

17. The electronic device as claimed in claim 7, further comprising another microphone module also disposed in the chamber, wherein the microphone modules are placed face-to-back.
